(19) United States
(12) Patent Application Publication
(10) Pub. No.: US 2015/0302355 A1
(43) Pub. Date: Oct. 22, 2015

(54) SYSTEMS AND METHODS FOR MANAGING JOB CANDIDATE INFORMATION AND PROPOSALS

(71) Applicant: The Boeing Company, Seal Beach, CA (US)

(72) Inventors: Brian C. Grubel, Glen Burnie, MD (US); Dion S.D. Reid, Grasonville, MD (US); Ryan A. Hendrickson, Hanover, MD (US); Meryl A. Glidewell, St. Louis, MO (US)

(73) Assignee: THE BOEING COMPANY, Seal Beach, CA (US)

(21) Appl. No.: 14/255,303

(22) Filed: Apr. 17, 2014

(51) Int. Cl. G06Q 10/10; G06F 17/30

(52) U.S. Cl. CPC G06Q 10/1053; G06F 17/30684

(57) ABSTRACT

A method for managing job candidate information is provided. The method is performed by a computing device coupled to a database. The method includes receiving, by the computing device, job candidate information, performing semantic analysis on at least a first portion of the job candidate information, generating a prompt for additional information based on the semantic analysis, combining the additional information with the job candidate information into a master candidate profile, and storing the master candidate profile in the database.

### BACKGROUND

The present disclosure relates generally to matching job candidates with jobs, and more specifically to performing semantic analysis on job candidate information to generate revised job candidate information to match criteria for a particular job.

In known systems, prospective candidates looking for work may maintain multiple versions of their curriculum vitae (CV) for different types of jobs. In other instances, a candidate maintains a single CV and attempts to make the CV applicable to multiple job types. Additionally, in proposal efforts, a volume lead must maintain and select CVs most appropriate to sets of qualifications, attributes, or other criteria for one or more job types (“customer labor categories”). This requires time-intensive human review on time-constrained proposal efforts. Moreover, such human review of CVs may not provide an objective method for rating CVs on their applicability or relevance to the customer labor categories. In some instances, the volume lead must work with candidates to reword CVs to ensure that the CVs meet customer labor category requirements while not overstating the qualifications of the candidates. In summary, while some known systems enable a person to manually generate multiple versions of CVs, such systems do not dynamically generate versions of the CV for the user, based on semantic analysis of information stored about a candidate and criteria included in a request for job candidates.

### BRIEF DESCRIPTION

In one aspect, a method for managing job candidate information is provided. The method is performed by a computing device coupled to a database. The method includes receiving, by the computing device, job candidate information, performing semantic analysis on at least a first portion of the job candidate information, generating a prompt for additional information based on the semantic analysis, combining the additional information with the job candidate information into a master candidate profile, and storing the master candidate profile in the database.

In another aspect, a computing device for managing job candidate information is provided. The computing device is coupled to a database. The computing device is configured to receive job candidate information, perform semantic analysis on at least a first portion of the job candidate information, generate a prompt for additional information based on the semantic analysis, combine the additional information with the job candidate information into a master candidate profile, and store the master candidate profile in the database.

In another aspect, a computer-readable storage medium having computer-executable instructions embodied thereon for managing job candidate information is provided. When executed by a computing device having at least one processor coupled to a database, the computer-executable instructions cause the computing device to receive job candidate information, perform semantic analysis on at least a first portion of the job candidate information, generate a prompt for additional information based on the semantic analysis, combine the additional information with the job candidate information into a master candidate profile, and store the master candidate profile in the database.

### BRIEF DESCRIPTION OF THE DRAWINGS

FIG. 1 is a simplified diagram of an example environment in which a job candidate management system receives job candidate information and requests for job candidates.

FIG. 2 is a simplified block diagram of the job candidate management system in communication with a database and other computing devices.

FIG. 3 is a block diagram of an example client computing device.

FIG. 4 is a block diagram of the job candidate management system of FIGS. 1 and 2.

FIG. 5 is a block diagram of example job candidate information.

FIG. 6 is a block diagram of an example request for at least one job candidate.

FIG. 7 is a block diagram of an example responsive candidate profile generated by the job candidate management system.

FIG. 8 is a flow chart of a process that may be performed by the job candidate management system for managing job candidate information.

### DETAILED DESCRIPTION

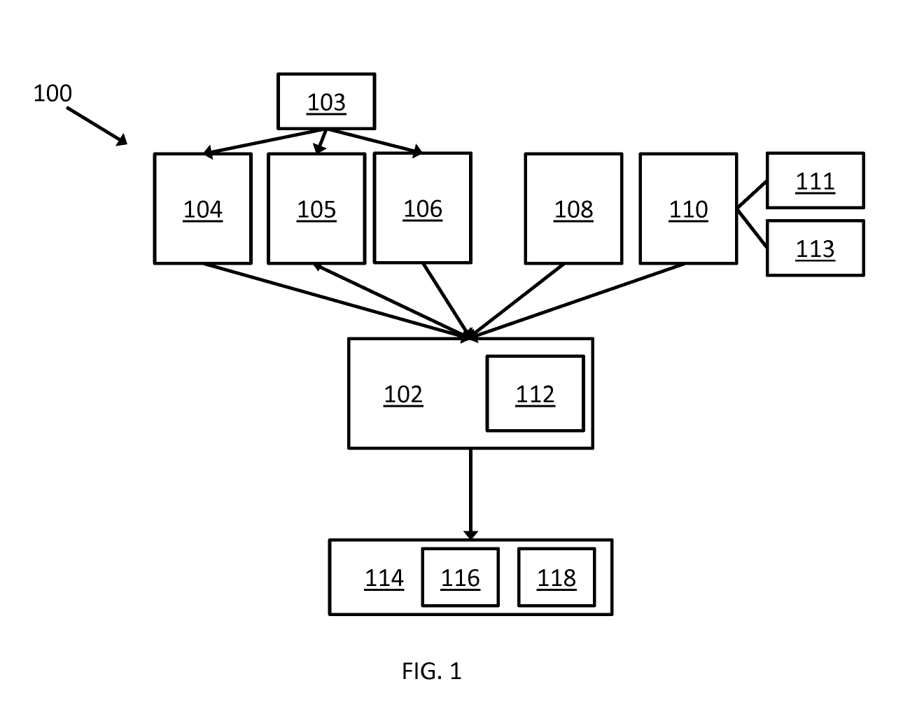

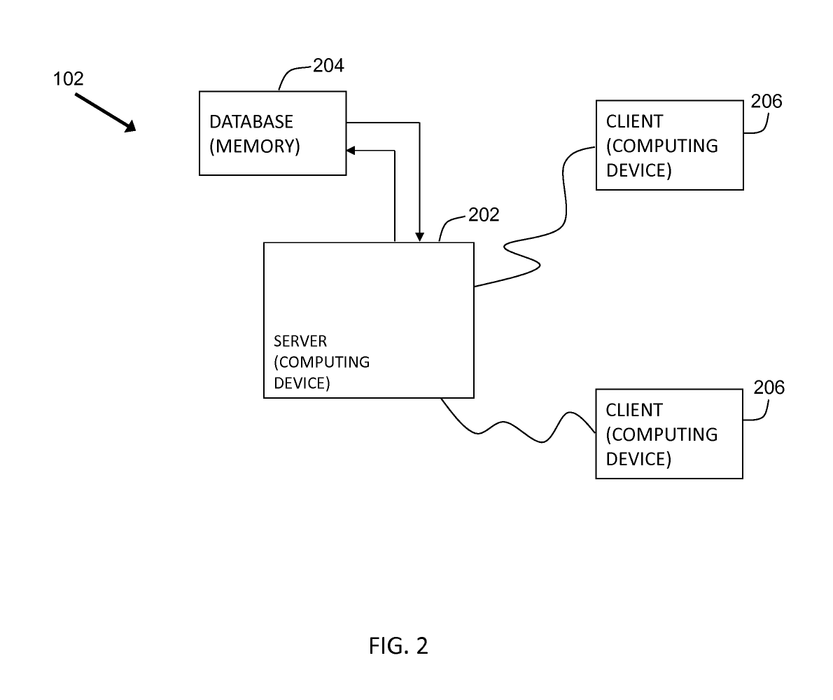

FIG. 1 is a simplified diagram of an example environment 100 in which a job candidate management system 102 receives job candidate information 104 and requests 108 for job candidates. More specifically, job candidate management system 102 receives job candidate information 104 such as at least one resume, curriculum vitae, and/or other descriptions of attributes associated with one or more candidates 103. In some implementations, job candidate information 104 is or includes information from a personnel profile, for example on a company intranet, a social networking profile, and/or a business networking profile of one or more candidates 103. Other descriptions of qualifications or attributes that may be included within job candidate information 104 may include, for example, rate information (e.g., cost per hour) charged by a company associated with candidate 103. As described in more detail herein, job candidate management system 102 performs semantic analysis on job candidate information 104 and generates one or more prompts 105 for additional information 106 regarding candidate 103, based on the semantic analysis. Job candidate management system 102 receives additional information 106, combines additional information 106 with job candidate information 104, and stores the combination as a master candidate profile 112 in a memory device, such as a database 204 (FIG. 2).

As described above, job candidate management system 102 receives at least one request 108 (“requisition”) for at least one candidate for a job (e.g., candidate 103). As described in more detail herein, request 108 includes criteria defining required and/or preferred attributes of at least one candidate for a job. Job candidate management system 102 performs semantic analysis on request 108 to understand the meaning of the criteria and to generate keywords based on the criteria in request 108. In some implementations, job candidate management system 102 also receives parameters 110 for example one or more goals 111 and/or one or more constraints 113. For example, goals 111 may include one or more of facilitating minimizing a total cost associated with one or more selected candidates 103, facilitating maximizing profit or revenue to a particular entity (i.e., company), and/or facilitating maximizing a relevance or matching score of selected candidates 103 to criteria in request 108. In some implementations, constraints 113 include one or more of meeting a predefined set of criteria in request 108, meeting a predefined number of staffing allocations per job category for each entity (i.e., company) for each year of a contract, meeting a predefined number of candidates from a particular entity (i.e., company), meeting predefined salary requirements, avoiding using information for a particular candidate 103 for multiple job categories, meeting requirements of staffing agreements (e.g., a requirement that a particular candidate 103 have a particular position on a leadership team). Job candidate management system 102 then searches for and selects at least one master candidate profile 112 based on the keywords and parameters 110.

Additionally, job candidate management system 102 generates output 114. For example, job candidate management system 102 reformats, rewords, and/or selects a subset of portions of the at least one selected master candidate profile 112 to generate a responsive candidate profile 116. Additionally, in some implementations, job candidate management system 102 generates and outputs at least one score 118 quantifying how closely the at least one responsive candidate profile 116 matches the criteria in request 108 and/or parameters 110. Some implementations allow using information for a particular candidate for multiple job categories, at least in some instances.

FIG. 2 is a simplified block diagram of job candidate management system 102 in communication with a database 204 and client computing devices 206. More specifically, in some implementations, job candidate management system 102 includes a server computing device 202 in communication with a database 204. In some implementations, one or more of client computing devices 206 transmit one or more of job candidate information 104, additional information 106, request 108, and parameters 110 to job candidate management system 102. Additionally, in some implementations, one or more of computing devices 206 receives one or more prompts 105 from job candidate management system 102. Additionally, in some implementations, one or more of computing devices 206 receives output 114 from job candidate management system 102.

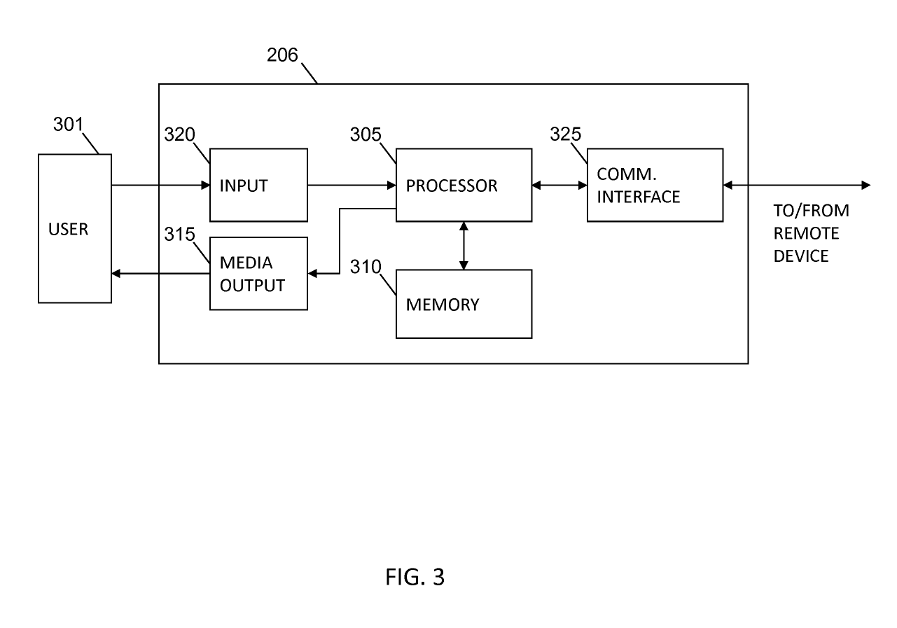

FIG. 3 is a block diagram of client computing device 206. Client computing device 206 includes one or more processors 305 for executing instructions. In some implementations, executable instructions are stored in a memory device 310. Processor 305 may include one or more processing units (e.g., in a multi-core configuration). One or more memory devices 310 are any one or more devices allowing information such as executable instructions and/or other data to be stored and retrieved. One or more memory devices 310 may include one or more computer-readable media.

Client computing device 206 also includes at least one media output component 315 for presenting information to a user 301. Media output component 315 is any component capable of conveying information to user 301. In some implementations, media output component 315 includes an output adapter such as a video adapter and/or an audio adapter. An output adapter is operatively coupled to processor 305 and operatively couplable to an output device such as a display device (e.g., a liquid crystal display (LCD), organic light emitting diode (OLED) display, cathode ray tube (CRT), or “electronic ink” display) or an audio output device (e.g., a speaker or headphones).

In some implementations, client computing device 206 includes an input device 320 for receiving input from user 301. Input device 320 may include, for example, a keyboard, a pointing device, a mouse, a stylus, a touch sensitive panel (e.g., a touch pad or a touch screen), a gyroscope, an accelerometer, a position detector, or an audio input device. A single component such as a touch screen may function as both an output device of media output component 315 and input device 320.

Client computing device 206 may also include a communication interface 325, which is communicatively couplable to a remote device such as server computing device 202 of job candidate management system 102. Communication interface 325 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in one or more memory devices 310 are, for example, computer-readable instructions for providing a user interface to user 301 via media output component 315 and, optionally, receiving and processing input from input device 320. A user interface may include, among other possibilities, a web browser and client application. Web browsers enable user 301, to display and interact with media and other information typically embedded on a web page or a website from server computing device 202. A client application allows user 301 to interact with a server application from server computing device 202.

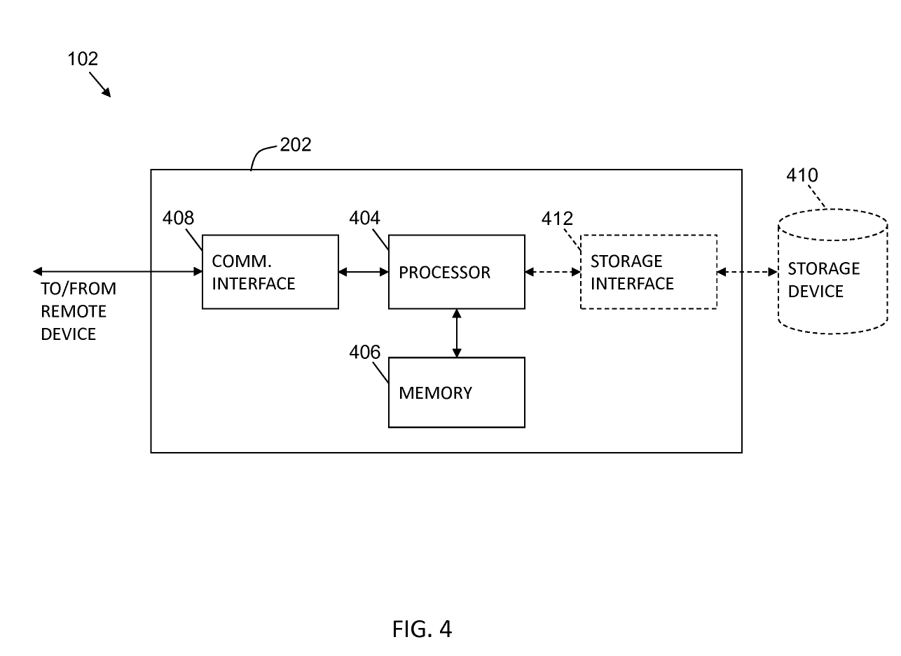

FIG. 4 is a block diagram of job candidate management system 102, and more specifically, server computing device 202. Server computing device 202 includes one or more processors 404 for executing instructions. Instructions may be stored in one or more memory devices 406, for example. One or more processors 404 may include one or more processing units (e.g., in a multi-core configuration). One or more processors 404 are operatively coupled to a communication interface 408 such that server computing device 202 is capable of communicating with a remote device such as client computing device 206 or another computing device.

One or more processors 404 may also be operatively coupled to one or more storage devices 410. One or more storage devices 410 are any computer-operated hardware suitable for storing and/or retrieving data. In some implementations, one or more storage devices 410 are integrated in server computing device 202. For example, server computing device 202 may include one or more hard disk drives as one or more storage devices 410. In other implementations, one or more storage devices 410 are external to server computing device 202 and may be accessed by a plurality of server computing devices 202. For example, one or more storage devices 410 may include multiple storage units such as hard disks or solid state disks in a redundant array of inexpensive disks (RAID) configuration. One or more storage devices 410 may include a storage area network (SAN) and/or a network attached storage (NAS) system. In some implementations, one or more storage devices 410 may include database 204.

In some implementations, one or more processors 404 are operatively coupled to one or more storage devices 410 via a storage interface 412. Storage interface 412 is any component capable of providing one or more processors 404 with access to one or more storage devices 410. Storage interface 412 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing one or more processors 404 with access to one or more storage devices 410.

One or more memory devices 310 and 406 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are example only, and are thus not limiting as to the types of memory usable for storage of a computer program.

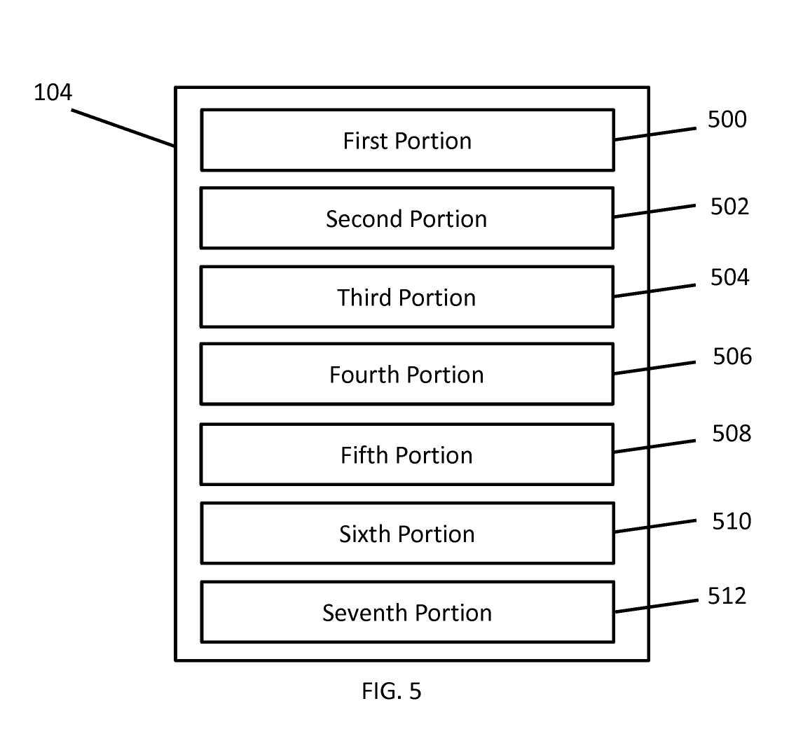

FIG. 5 is a block diagram of job candidate information 104. Job candidate information 104 may include at least one resume, curriculum vitae, and/or other descriptions of attributes associated with candidate 103, and is partitioned into a first portion 500, a second portion 502, a third portion 504, a fourth portion 506, a fifth portion 508, a sixth portion 510, and a seventh portion 512. In other implementations, job candidate information 104 includes a different number of portions. Job candidate management system 102 performs semantic analysis on job candidate information 104 and generates at least one prompt 105 (FIG. 1) for additional information 106. For example, job candidate management system 102 may identify the term “undergrad degree” and one or more course names pertaining to engineering, in first portion 500, and transmit prompt 105 to client computing device 206 to confirm that the “undergrad degree” is a bachelor's degree in science. Additionally, job candidate management system 102 may determine a likely major associated with the bachelor's degree, based on semantic analysis of the course names, and transmit prompt 105 for confirmation that the major is computer engineering. Job candidate management system 102 receives additional information 106 from client computing device 206 in the form of confirmations that the undergrad degree is a bachelor's degree in science and that the major is computer engineering. Job candidate management system 102 stores additional information 106 in association with job candidate information 104 as master candidate profile 112, for example in database 204 (FIG. 2).

In some implementations, job candidate management system 102 may identify acronyms or shorthand references for certifications, procedures that candidate 103 is skilled in, software that candidate 103 has experience using, and/or other items, and generate prompts 105 for confirmation or clarification on what the acronyms or shorthand references represent. Job candidate management system 102 stores corresponding additional information 106 based on such prompts 105 in master candidate profile 112. In some implementations, job candidate management system 102 also obtains additional information 106 from one or more external or third party computing devices or databases (not shown), and can be updated based upon user input. For example, job candidate management system 102 enables users to define an acronym list that is tailored to a specific domain of an application. For example, one particular acronym may mean one thing to customer A and mean something completely different to customer B. Job candidate management system 102 enables various partitions of data for similar terms.

In some implementations, job candidate management system 102 transmits prompt 105 to client computing device 206 requesting metrics data. For example, job candidate management system 102 may identify that third portion 504 indicates that candidate 103 lead a team to develop an improved version of a particular product. Accordingly, job candidate management system 102 generates and transmits one or more prompts 105 for metrics, for example, the size of the team, a budget associated with developing the product, a number of units sold, an amount of money saved, and/or other performance metrics. Job candidate management system 102 receives the metrics from client computing device 206 as additional information 106 and stores additional information 106 in master candidate profile 112.

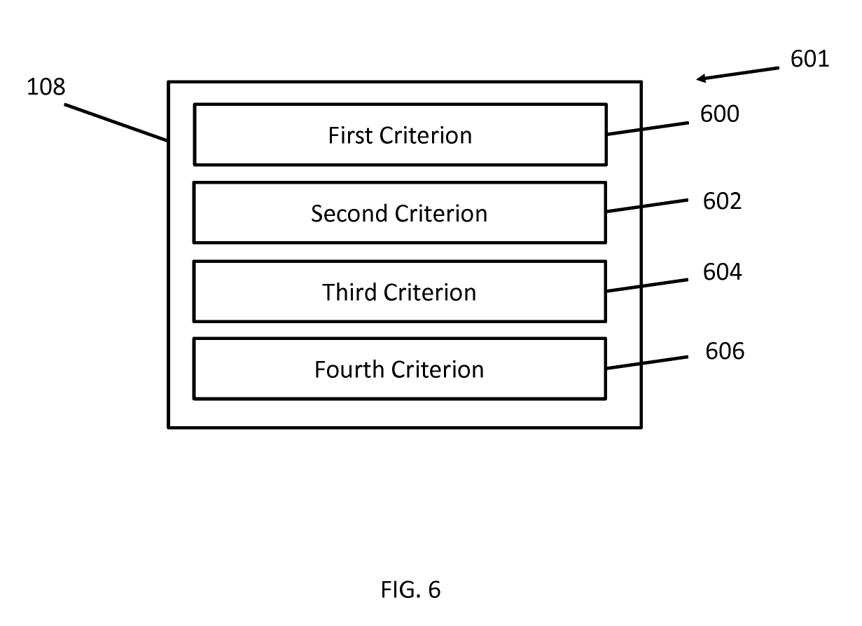

FIG. 6 is a block diagram of request 108 for at least one job candidate. Request 108 includes a first criterion 600, a second criterion 602, a third criterion 604, and a fourth criterion 606. In some implementations, request 108 includes a different number of criteria 601. In some implementations, job candidate management system 102 performs semantic analysis on criteria 601 and determines that one or more criteria 601 (e.g., first criterion 600 and second criterion 602) are required, based on matching words in request 108 with words from a first predefined list stored in database 204. The first predefined list may include, for example, “must” and “required”. Additionally, job candidate management system 102 determines that one or more other criteria (e.g., third criterion 604 and fourth criterion 606) are optional or preferred, by matching words in request 108 with words from a second predefined list stored in database 204. The second predefined list may include, for example, “should”, “preferably”, and/or “optionally”. Job candidate management system 102 then assigns weights to each of first criterion 600, second criterion 602, third criterion 604, and fourth criterion 606 based on whether each criterion is required or merely preferred.

Job candidate management system 102 also generates one or more keywords for searching one or more stored master candidate profiles 112, based on the semantic analysis of request 108. In some implementations, job candidate management system 102 identifies that certain criteria 601, for example first criterion 600, states a required attribute of a candidate in one or more first words, and translates the one or more first words into second words that are used to express the same attribute in one or more master candidate profiles 112. For example, job candidate management system 102 may determine that “computer engineer III” in first criterion 600 is categorized or expressed as “computer engineer II” in master candidate profiles 112, because an entity that submitted request 108 uses a first categorization system than differs from a second categorization system used by job candidate management system 102 when generating and storing master candidate profiles 112.

Job candidate management system 102 searches stored master candidate profiles 112 based on the keywords. In implementations in which job candidate management system 102 generates weights based on whether certain criteria are required or merely preferred, job candidate management system 102 weights the keywords accordingly. In some implementations, job candidate management system 102 identifies terms that are of similar context. For example, if the requirement is that the candidate must have experience with Java on the CV, job candidate management system 102 may prompt the user for more information, provide different details options similar to Java, or simply state that the candidate has equivalent software development experience. All options are approaches that may increase the probability of customer acceptance. In implementations in which job candidate management system 102 receives one or more parameters 110 (i.e., goals 111 and/or constraints 113), as described above, job candidate management system 102 bases the search additionally on parameters 110.

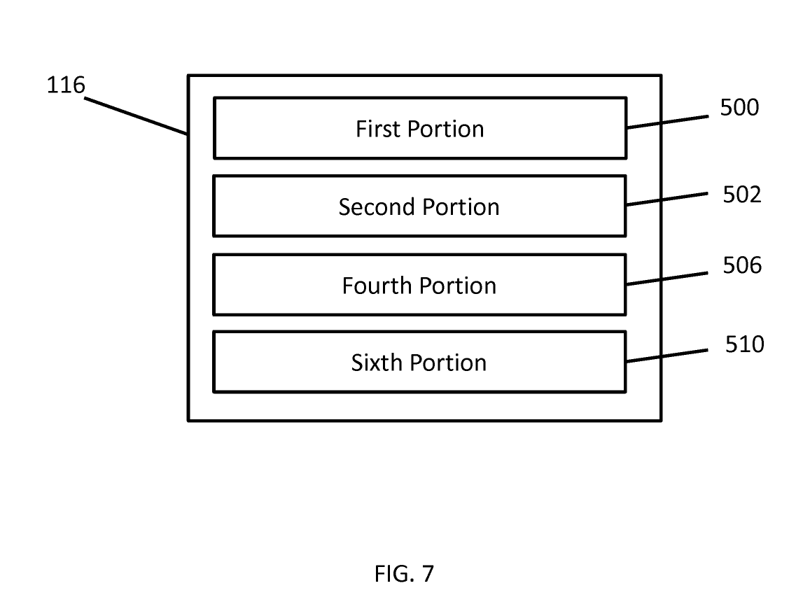

FIG. 7 is a block diagram of responsive candidate profile 116, which is generated by job candidate management system 102. More specifically, based on criteria 601 (e.g., first criterion 600, second criterion 602, third criterion 604, and fourth criterion 606) of request 108, and parameters 110, job candidate management system 102 selects at least one master candidate profile 112 in response to request 108. In generating responsive candidate profile 116, job candidate management system 102 may select a subset of job candidate information 104 and/or additional information 106 from master candidate profile 112. More specifically, job candidate management system 102 selects first portion 500, second portion 502, fourth portion 506, and sixth portion 510 of job candidate information 104, stored in master candidate profile 112, for inclusion in responsive candidate profile 116. In other words, job candidate management system 102 determines that other portions of master candidate profile 112, including third portion 504, fifth portion 508, and seventh portion 512 of job candidate information 104 should be excluded based on the semantic analysis of job candidate information 104, the semantic analysis of request 108, parameters 110, and/or other factors. For example, job candidate management system 102 may determine that third portion 504, fifth portion 508, and seventh portion 512 of job candidate information 104 are extraneous or irrelevant in view of request 108. In some implementations, job candidate management system 102 determines that one or more pieces of data within each portion is extraneous or irrelevant in view of request 108. In some implementations, job candidate management system 102 may format responsive candidate profile 116 according to formatting rules specified in request 108 and/or input from another source (e.g., user 301 through client computing device 206). Additionally, job candidate management system 102 outputs score 118 representing how well responsive candidate profile 116 meets request 108 and/or parameters 110. Score 118 may be, for example, a numeric score ranging, for example, from 0 to 100.

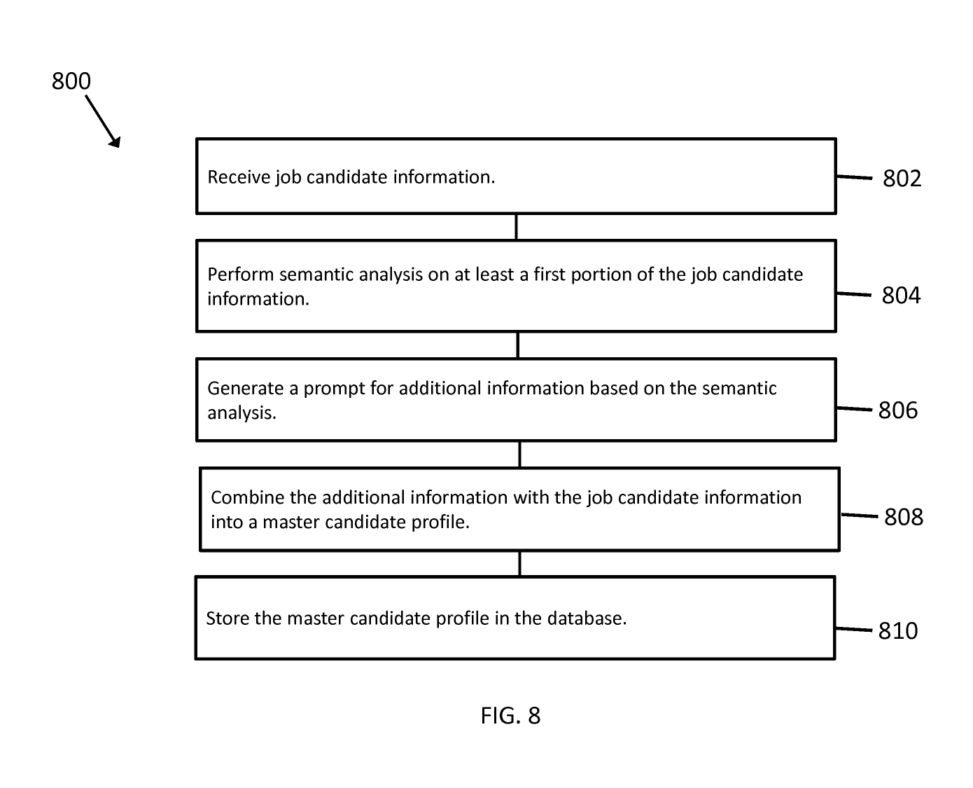

FIG. 8 is a flow chart of a process 800 that may be performed by job candidate management system 102 for managing job candidate information 104. Initially, job candidate management system 102 receives 802 job candidate information 104, for example, from one of client computing devices 206. As describe above, job candidate information 104 may include, for example, at least one resume, curriculum vitae, or other description of qualifications or attributes of candidate 103. Additionally, job candidate management system 102 performs 804 a semantic analysis on at least first portion (e.g., first portion 500) of job candidate information 104. Additionally, job candidate management system 102 generates 806 a prompt (e.g., prompt 105) for additional information 106 based on the semantic analysis. Job candidate management system 102 additionally combines 808 additional information 106 with job candidate information 104 into a master candidate profile (e.g., master candidate profile 112) and stores 810 master candidate profile 112 in a database (e.g., database 204).

In some implementations, job candidate management system 102 generates a variation on first portion 500, or any other portion, of job candidate information 104, based on the semantic analysis. The variation may be, for example, a rewording, clarification of a shorthand reference or acronym, and/or inclusion of additional details, into first portion 500. In some implementations, generating prompt 105 includes generating a prompt to verify a correctness of the variation. In some implementations, generating prompt 105 includes generating a prompt for metrics data pertaining to first portion 500. In some implementations, job candidate management system 102 additionally receives a request (e.g., request 108) for at least one candidate for a job, wherein request 108 includes a first set of criteria (e.g., first criterion 600, second criterion 602, third criterion 604, and fourth criterion 606). Additionally, in some implementations, job candidate management system 102 searches database 204 for a matching master candidate profile 112 based on the criteria. Additionally, in some implementations, job candidate management system 102 generates a responsive candidate profile (e.g., responsive candidate profile 116), wherein responsive candidate profile 116 includes at least a subset of master candidate profile (e.g., first portion 500, second portion 502, fourth portion 506, and sixth portion 510 of job candidate information 104). In some implementations, job candidate management system 102 performs semantic analysis of the criteria in request 108 to extract one or more keywords for use in searching for at least one matching master candidate profile 112. In some implementations, job candidate management system 102 receives parameters 110 specifying, for example, at least one goal 111 for optimization and/or at least one constraint 113 for use in optimization. In some implementations, job candidate management system 102 generates at least one score 118, for example a score that represents a relevance of a responsive candidate profile 116 to request 108 and/or parameters 110.

In some implementations, job candidate management system 102 enables user 301 to edit a responsive candidate profile 116 for formatting or other changes after job candidate management system 102 has generated responsive candidate profile 116. In some implementations, job candidate management system 102 enables user 301 to provide formatting requirements, for example a page limit, font size, and/or spacing configurations for responsive candidate profile 116. In response, job candidate management system 102 selects the most pertinent portions of the corresponding master candidate profile 112 to fit within the page limit of responsive candidate profile 116. In some implementations, job candidate management system 102 enables user 301 to select an option to disable semantic analysis and to only vary or enhance the wording in the job candidate information 104 (e.g., resume or CV). In some implementations, job candidate management system 102 enables manual editing after the semantic analysis and saving as a configuration controlled version of the master candidate profile. In some implementations, job candidate management system 102 performs an analysis of a master candidate profile 112 and/or a responsive candidate profile 116 for strengths and weaknesses relative to criteria in one or more requests 108. In some implementations, job candidate management system 102 identifies one or more of the strengths and/or weaknesses for discussion with the candidate, and updates the master candidate profile 112 and/or responsive candidate profile 116 based on the discussion. In some implementations, job candidate management system 102 generates and outputs, for example to client computing device 206, before and after representations of information pertaining to candidate 103, such as a representation of job candidate information 104 and a representation of responsive candidate profile 116, and includes visual indicators, for example highlights, indicating what information was changed and/or a reason why job candidate management system 102 made the change (e.g., to express a qualification or attribute of a candidate using a word included in the criteria of request 108). In some implementations, job candidate management system 102 stores multiple responsive candidate profiles 116 for candidate 103, for example, one responsive candidate profile 116 for each of a plurality of requests 108 (e.g., job profiles or requirements).

Additionally, in some implementations, job candidate management system 102 maintains configuration control of responsive candidate profiles 116 for each of a plurality of requests 108. In some implementations, job candidate management system 102 provides account creation and access control, and provides role-based security for controlling access to at least one of job candidate information 104, requests 108, master candidate profiles 112, and responsive candidate profiles 116. In some implementations, job candidate management system 102 performs an initial analysis of labor categories from one or more requests 108 and determines a requirement verification percentage and/or percentage match to a given labor category. In some implementations, job candidate management system 102 generates a visual comparison between responsive candidate profile 116 and criteria in request 108, for review by user 301. Such information may enable user 301 (i.e., a volume lead) in determining which candidates 103 best meet criteria in one or more requests 108.

In performing semantic analysis, some implementations of job candidate management system 102 may categorize information, generate tags from a controlled taxonomy and assert a relative importance of each tag with respect to the categorized information, locate related information through external resources (i.e., external computing devices and/or databases), extract and recognize entities from information submitted by user 301 through client computing device 206, detect yet unknown entities for storage in database 204, and extract knowledge assertions from information submitted by user 301 to populate a database (e.g., database 204), along with a corresponding reference to trace an origin of the assertion.

In some implementations, job candidate management system 102 may generate metrics that represent multiple points along a Pareto frontier with different configurations of job candidate assignments and resulting costs, showing different scores in n-dimensional space (goals). For example, if there are four objectives (goals), job candidate management system 102 would display the objective score for each one and tradeoffs between them. Such implementations enable the user to modify multi-objective weightings between objectives to fine tune overall objectives. For example, a proposal manager may determine that a particular objective is now more important than another objective. Job candidate management system 102 may perform such functions using linear combinations of weightings and/or other methods of combining weightings. In some implementations, job candidate management system 102 may enable user 301 to use calculated Pareto configurations as a starting point and modify the configuration pursuant to input from user 301. For example, user 301 may provide goals 111 and/or constraints 113. In response, such implementations of job candidate management system 102 recalculate Pareto configurations based on goals 111 and/or constraints 113. In some implementations, job candidate management system 102 continuously performs optimization calculations based on goals 111 and/or constraints 113 upon the input of new data (e.g., more CVs were added to database 204, and/or other settings, variables, or data was added, deleted, or changed). Additionally, in some implementations, job candidate management system 102 saves historic configurations, for example in database 204, for review by user 301.

In some implementations, job candidate management system 102 is integrated with a social media system (not shown) that enables the user to continuously update certain aspects of their job candidate information 104 and/or master candidate profile 112 based upon changing proposal requirements. In some implementations, there may be, for example, 100 different proposal teams using job candidate management system 102 and all of the teams are searching a large organization for candidates. Changes to the input requirements may generate updated questions and clarifications to a generic employee using the social media system. In some implementations, job candidate management system 102 additionally updates master candidate profile 112 with a version of a CV that applies to the specific requirements of a single proposal effort.

In some implementations, job candidate management system 102 recommends different labor categories that a candidate may be a better fit for, and provides the user with the option to allow certain companies to apply a single CV to multiple labor categories. In some implementations, job candidate management system 102 rewords information provided in a CV (job candidate information 104) such that the corresponding master candidate profile 112 and/or responsive candidate profile 116 would meet the requirements of request 108.

In some implementations, job candidate management system 102 generates delta reports over time, indicating which job candidates are available at different points in time and how such information affects effort or statistics. More specifically, in some implementations, job candidate management system 102 performs continuous monitoring of proposed resources, rather than at a single point in time. Such implementations may be beneficial when people take other positions or new people become available as the length of a proposal may stretch up to a year or more in some instances.

In some implementations, job candidate management system 102 may enable creating queries for job websites (e.g., LinkedIn.com) to discover high-percentage matches for proposal efforts to pursue. In some implementations, job candidate management system 102 identifies rare or elite skills that may be difficult to find in candidates that fall within a certain rate range. In some implementations, job candidate management system 102 automatically provides secondary options such as best percentage available at rate, best percentage at rate+x, rate+y, etc. Such implementations provide a secondary option of paying beyond the range or determining if active recruitment keyed those rare or elite skills is necessary (e.g., additional finder's fee).

A technical effect of systems and methods described herein includes at least one of: (a) receiving job candidate information; (b) performing semantic analysis on at least a first portion of the job candidate information; (c) generating a prompt for additional information based on the semantic analysis; (d) combining the additional information with the job candidate information into a master candidate profile; and (e) storing the master candidate profile in a database.

As compared to known methods and systems for managing job candidate information, the methods and systems described herein perform semantic analysis on job candidate information to generate candidate profiles (e.g., resumes or CVs) that are tailored to match criteria included in requests for job candidates.

The description of the different advantageous implementations has been presented for purposes of illustration and description, and is not intended to be exhaustive or limited to the implementations in the form disclosed. Many modifications and variations will be apparent to those of ordinary skill in the art. Further, different advantageous implementations may provide different advantages as compared to other advantageous implementations. The implementation or implementations selected are chosen and described in order to best explain the principles of the implementations, the practical application, and to enable others of ordinary skill in the art to understand the disclosure for various implementations with various modifications as are suited to the particular use contemplated. This written description uses examples to disclose various implementations, which include the best mode, to enable any person skilled in the art to practice those implementations, including making and using any devices or systems and performing any incorporated methods. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method for managing job candidate information, the method is performed by a computing device coupled to a database, the method comprising:
receiving, by the computing device, job candidate information;
performing semantic analysis on at least a first portion of the job candidate information;
generating a prompt for additional information based on the semantic analysis;
combining the additional information with the job candidate information into a master candidate profile; and
storing the master candidate profile in the database.

2. The method of claim 1, further comprising generating a variation on the first portion, based on the semantic analysis and wherein generating a prompt comprises generating a prompt to verify a correctness of the variation on the first portion.

3. The method of claim 1, wherein generating a prompt comprises generating a prompt for metrics data.

4. The method of claim 1, further comprising:
receiving a request for at least one candidate for a job, the request including criteria;
searching the database for a matching master candidate profile, based at least in part on the criteria; and
generating a responsive candidate profile, the responsive candidate profile including at least a subset of the master candidate profile.

5. The method of claim 4, further comprising performing semantic analysis on the criteria to extract one or more keywords.

6. The method of claim 4, wherein searching the database further comprises searching the database for the matching master candidate profile based on at least one optimization goal.

7. The method of claim 4, wherein searching the database further comprises searching the database for the matching master candidate profile based on at least one constraint.

8. The method of claim 4, further comprising generating a relevance score for the responsive candidate profile.

9. The method of claim 4, wherein generating a responsive candidate profile further comprises at least one of reformatting and rewording the matching master candidate profile.

10. The method of claim 4, further comprising enabling access to at least one of the master candidate profile and the request based on a role of a user.

11. A computing device for managing job candidate information, said computing device is coupled to a database, said computing device configured to:
receive job candidate information;
perform semantic analysis on at least a first portion of the job candidate information;
generate a prompt for additional information based on the semantic analysis;
combine the additional information with the job candidate information into a master candidate profile; and
store the master candidate profile in the database.

12. The computing device of claim 11, further configured to:
generate a variation on the first portion, based on the semantic analysis; and
generate a prompt to verify a correctness of the variation on the first portion.

13. The computing device of claim 11, further configured to generate a prompt for metrics data.

14. The computing device of claim 11, further configured to:
receive a request for at least one candidate for a job, the request including criteria;
search the database for a matching master candidate profile, based on the criteria; and
generating a responsive candidate profile, the responsive candidate profile including at least a subset of the master candidate profile.

15. The computing device of claim 14, further configured to perform semantic analysis on the criteria to extract one or more keywords.

16. The computing device of claim 14, further configured to search the database for the matching master candidate profile based on at least one optimization goal.

17. The computing device of claim 14, further configured to search the database for the matching master candidate profile based on at least one constraint.

18. The computing device of claim 14, further configured to generate a relevance score for the responsive candidate profile.

19. The computing device of claim 14, further configured to at least one of reformat and reword the matching master candidate profile.

20. A computer-readable storage medium having computer-executable instructions embodied thereon for managing job candidate information, wherein when executed by a computing device having at least one processor coupled to a database, the computer-executable instructions cause the computing device to:
receive job candidate information;
perform semantic analysis on at least a first portion of the job candidate information;
generate a prompt for additional information based on the semantic analysis;
combine the additional information with the job candidate information into a master candidate profile; and
store the master candidate profile in the database.
